(19) United States
(12) Patent Application Publication
(10) Pub. No.: US 2011/0163190 A1
(43) Pub. Date: Jul. 7, 2011

(54) SCRAP TIRE RECYCLING PLANT

(76) Inventor: Roberto Verri, Milano (IT)

(21) Appl. No.: 13/060,526

(22) PCT Filed: Aug. 29, 2008
(86) PCT No.: PCT/IT2008/000562

§ 371 Date: Feb. 24, 2011

(51) Int. Cl. B02C 23/18

(52) U.S. Cl. 241/15; 241/39

(57) ABSTRACT

The present invention relates to a device, a plant and a method for disgregating scrap tires, which provide recycled material (rubber crumbs, metal, textile product) having a very high degree of purity. The device, plant and method of the present invention further provide a high yield of material per time unit. In practice, the present invention concerns disgregation of scrap tire shoulders.

### TECHNICAL FIELD

The present invention relates to a scrap tire recycling plant.

### BACKGROUND OF THE INVENTION

Modern society is mainly based on road transport: cars, motorcycles, tractors and trucks are some of means of transport that manifestly use tires every day.

Tires are known to have a limited life and have to be replaced when they become useless. Unusable tires, such as excessively worn or damaged tires, are known as scrap tires.

Scrap tires are a contaminating product, one tire, e.g., a car tire, taking about 100 years to full disposal.

Considering that scrap tires can be counted in hundreds of millions in the industrialized world, it is clear that they create a major environmental concern.

Any scrap tire recycling attempt performed so far has addressed the problem of separating scrap tires into their main components: textiles, metals (typically steel) and rubber.

Some of the mechanical scrap tire recycling plants known in the art, e.g., from RO118939, can recover a more or less substantial portion of the rubber, but do not address the problem of recovering the other components.

In the art of scrap tire recycling, plants are also known that use high pressure water jets for disgregating scrap tires. Particularly, in the Water Jet technology, the scrap tire is hit with a very high pressure water jet (maximum pressure achieved in this technology being about 4000 bar). In certain cases, the water jet, controlled by a Cartesian-coordinate robot or an anthropomorphic arm, follows a predetermined path based on a particular program.

Particularly, U.S. Pat. No. 5,341,996 discloses the use of Water Jet technology to disgregate rubber for later recovery.

Nonetheless, the plant disclosed therein does not ensure a high yield (in terms of rubber recovered per time unit) and is not able to perfectly clean the metal cording; due to their poor purity, the products recovered thereby are rather difficultly marketable.

### SUMMARY OF THE INVENTION

In view of the prior art as described above, the object of the present invention is to provide a scrap tire recycling plant ensuring an excellent yield per time unit in terms of recovered material, i.e., rubber, metal and textile material, as well as a high purity of the recovered material.

According to the present invention, this object is fulfilled by a device for destructing tires which comprise a tread and two shoulders substantially parallel to each other and substantially perpendicular to said tread, particularly for scrap tires, said device comprising a support for one or more of said tires, comprising a seat which is adapted to receive said one or more tires concentrically with a substantially vertical main axis, a Water Jet system for disgregating at least one portion of said tires, said device comprising pressing means, for pressing said shoulders of said scrap tire towards each other in said axial direction.

According to a further aspect, this object is fulfilled by a plant for disgregating tires comprising a device for destructing tires which comprise a tread and two shoulders substantially parallel to each other and substantially perpendicular to said tread, particularly for scrap tires, said device comprising a support for one or more of said tires, comprising a seat which is adapted to receive said one or more tires concentrically with a substantially vertical main axis, a Water Jet system for disgregating at least one portion of said tires, said device comprising pressing means, for pressing said shoulders of said scrap tire towards each other in said axial direction.

According to a further aspect, this object is fulfilled by a method for disgregating the shoulders of tires which comprise a tread and two shoulders substantially parallel to each other and substantially perpendicular to said tread, particularly for scrap tires, comprising the steps of laying one or more of said tires concentrically with a substantially vertical main axis, disgregating the tread of said one or more of said tires, moving said shoulders of said one or more tires towards each other along said main axis, disgregating said shoulders of said one or more tires.

In practice, the present invention provides a plant in which scrap tires are disgregated and separated into their components (rubber, metal and textile material) through successive processing steps. The components so obtained have a higher commercial value than those provided by prior art plants, due to their higher purity.

### BRIEF DESCRIPTION OF THE DRAWINGS

The features and advantages of the present invention will appear from the following detailed description of one practical embodiment, which is illustrated without limitation in the annexed drawings, in which:

FIG. 1 is a general diagrammatic view of a preferred embodiment of a plant of the present invention; and

FIG. 2 is a diagrammatic view of a device of the second workstation of the plant of FIG. 1.

### DETAILED DESCRIPTION OF THE PREFERRED EMBODIMENTS

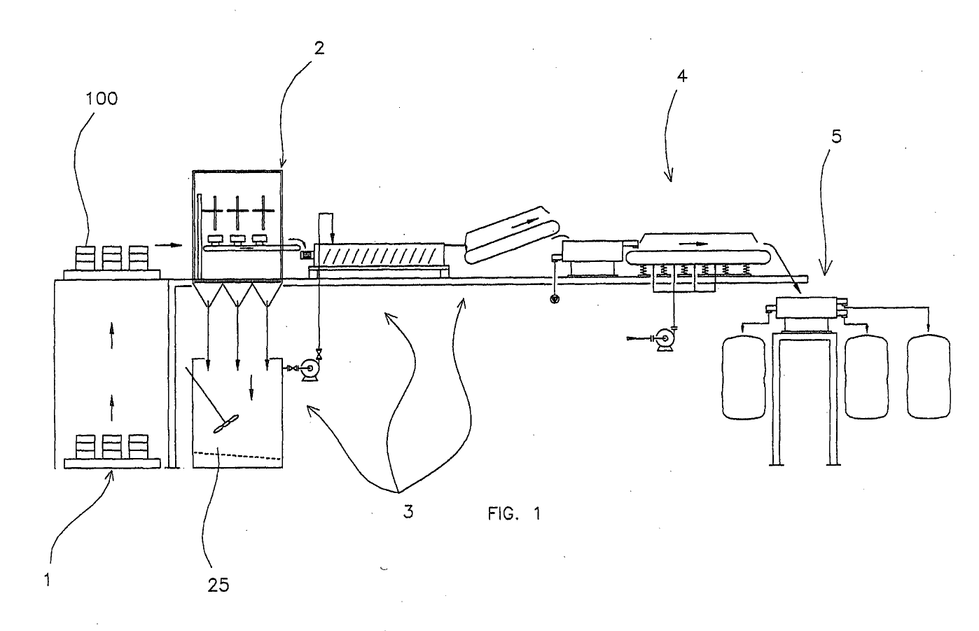

Referring to FIG. 1, the plant may comprise a plurality of workstations: the first station 1 may be an “intelligent” station in which scrap tires 100 are pre-selected and loaded into the second station 2, which may be a scrap tire 100 disgregating station, possibly having a device, e.g., a Water Jet device, for disgregating the rubber and fabric of the tread 101 and/or the shoulder 102 and/or means for separating the residual metal material.

The rubber and fabric disgregated into crumbs and fibers by the second station 2 may be collected with the Water Jet pump liquids in a third station 3 which provides, possibly at a later time, a (rubber or fiber) powder having a very low moisture content.

A fourth station 4 separates the rubber crumbs from the textile particles while further drying the product and conveys the rubber crumbs to a fifth screening station 5, in which the crumbs are separated according to their size.

A plant of this type provides an unprecedented material purity as well as a high yield per time unit.

The second station 2 comprises a device with a seat 10 for loading tires 100, preferably car and/or truck scrap tires, comprising a tread 101 and two shoulders 102, in which the shoulders 102 are substantially parallel to each other and substantially perpendicular to the tread 101, and in which the scrap tires 100 are concentric with a substantially vertical main axis X-X.

The device of the second station 2 also comprises pressing means 11, for pressing the shoulders 102 of the scrap tire 100 towards each other in the axial direction X-X.

Advantageously, the pressing means 11 comprise a pushing member 12 movable in the axial direction X-X.

The pushing member 12 is preferably situated at the distal end 13 of a radial arm 14; the proximal end 15 of the radial arm 14 is advantageously secured to the lower end 16 (or hub) of a first vertical arm 17. Advantageously, the lower end 16 is movable in the axial direction X-X, whereas the radial arm 14 may be axially fixed relative to the lower end 16.

Advantageously, the pressing means 11 comprise a plurality of, preferably three or four, radial arms 14, so to exert a substantially radially balanced pressure upon the shoulders 102 of the scrap tires 100; preferably a plurality of (such as three or four) radially equally spaced radial arms 14 are secured to a first vertical arm 17.

Each radial arm 14 may be equipped with a pushing member 12.

Advantageously, the distal end 13 of the radial arm 14 is radially movable towards and away from the axis X-X, to fit different diameters of different scrap tires 100 accommodated in the seat 10.

The distal ends 13 may be radially moved using appropriate control and operation means (not shown), for the pushing members 12 to be disposed axially above the shoulders 102 of the scrap tires.

Advantageously, the pushing member 12 has a substantially triangular or wedge shape, when viewed in the radial direction, for reasons to be further explained below.

The device of the second station 2 may comprise a Water Jet tool 18 for disgregating the shoulders 102 of the scrap tires 100 accommodated in the seat 10.

The Water Jet tool 18, which may be as known in the art and have one or more nozzles, is conveniently placed at the lower end 19 of a second vertical arm 20, and movable in the axial direction.

Therefore, the lower end 19 is axially movable and is axially integral with the Water Jet tool 18.

The first and second vertical arms 17, 20 are advantageously disposed on a second radial arm 21, preferably on a common radial axis 21, although other arrangements may be envisaged.

Advantageously, the second radial arm 21 is movable between a first operating state, in which it allows operation of the pressing means 11 and of the Water Jet tool 18 on the scrap tires 100 in the seat 10, and a second rest state, in which such operations are not possible.

Advantageously, the motion between the first and second states is a rotary motion about a second axis Y-Y, parallel to the axis X-X, but spaced therefrom.

The second radial arm 21 has such a length that, when the second radial arm 21 is in the first operating state, the first vertical arm 17 is substantially aligned with the axis X-X.

The second vertical arm 20 may be also arranged to be driven by appropriate actuator means 22 to move along the second radial arm 21.

Advantageously, the second radial arm 21 is also movable in the axial direction, driven by appropriate actuator means 23.

The pressing means 11 of the device of the second station 2, as well as appropriate control and operation means for carrying out the operations as described below, are typically mounted to an appropriate Cartesian structure.

Once one or more scrap tires 100 (e.g., three scrap tires 100) have been loaded into the seat 10 concentrically with the axis X-X, special Water Jet tools (not shown) disgregate a portion of the tread 101, preferably substantially the whole tread 101.

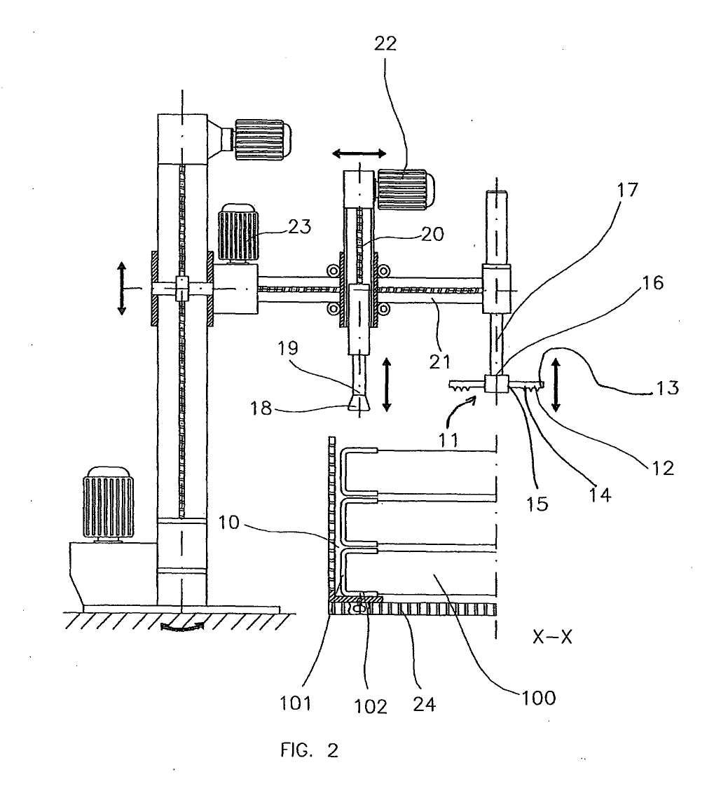

Then, the pressing means 11 move axially downwards to press together all the shoulders 102 of the one or more scrap tires 100 in the seat 10 (see FIG. 2).

Upon contact of the shoulders 102, the Water Jet tool 18 operates to disgregate the shoulders 102 of the scrap tires 100.

Namely, during disgregation of the treads 101, the pressing means 11 are in the second state, to avoid any interference with the above operations, and only come into operation when the tread 101 has been substantially fully disgregated.

Once the seat 10 is clear, the pressing means 11 are moved into the first operating state, and the pushing members 12 are disposed radially above the shoulders 102 of the scrap tires (which are still held in their original position by the metal part of the scrap tires 100, which extends also beyond the tread 101) and are pressed downwards.

Thus, the shoulders 102 of the scrap tires are pressed together substantially to contact, thereby forming a substantially solid rubber ring.

Then, the Water Jet tool 18 is disposed at a proper radial distance, so to be axially above the shoulders 102 of the scrap tires 100, and is operated to disgregate the shoulders 102 by Water Jet action.

During disgregation of the shoulders 102, the Water Jet tool 18 will have to pass above the pressing means 11. In this case, an advantageous downwardly directed wedge or triangular shape (when viewed in the radial direction) of the pushing members reduces the area not subjected to the action of the Water Jet tool 18 to a very small size, to such an extent that the final result is unaffected.

Once the above operations have been completed, the pressing means 11 are moved back to the second rest state.

Therefore, the seat 10 may comprise pressing means 11 as described above and Water Jet means for disgregating the tread 101 of the scrap tires 100 (not shown) and/or means (not shown) for removing the metal residue from the seat 10 at the end of the scrap tire disgregation operations.

The seat 10 also comprises a base 24 which advantageously has apertures for discharging the rubber, the textile residues and the water into an underlying tank 25 (see FIG. 1).

Obviously, while reference has been made herein to scrap tires, the present plant is also intended to be capable of processing perfectly usable tires and not necessarily scrap tires.

Those skilled in the art will obviously appreciate that a number of changes and variants may be made to the arrangements as described hereinbefore to meet incidental and specific needs, without departure from the scope of the invention, as defined in the following claims.

1-13. (canceled)

14. A device for destructing tires which comprise a tread and two shoulders substantially parallel to each other and substantially perpendicular to said tread, particularly for scrap tires, said device comprising:
a support for one or more of said tires, comprising a seat which is adapted to receive said one or more tires concentrically with a substantially vertical main axis,
a Water Jet system for disgregating at least one portion of said tires; and
wherein said device comprises pressing means, for pressing said shoulders of said scrap tire towards each other in said axial direction.

15. A device as claimed in claim 14, wherein said pressing means comprise a pushing member movable in said axial direction.

16. A device as claimed in claim 15, wherein said pressing means also comprise at least one radial arm having a distal end, said distal end being equipped with said pushing member.

17. A device as claimed in claim 16, wherein said pressing means comprise a first vertical arm having a lower end movable in said axial direction, the proximal end of said radial arm being secured to said movable lower end.

18. A device as claimed in claim 16, wherein said pressing means comprise three radial arms, each having at least one pushing member.

19. A device as claimed in claim 17, wherein said pressing means comprise three radial arms, each having at least one pushing member.

20. A device as claimed in claim 16, wherein said distal end is movable in the radial direction.

21. A device as claimed in claim 17, wherein said distal end is movable in the radial direction.

22. A device as claimed in claim 18, wherein said distal end is movable in the radial direction.

23. A device as claimed in claim 15, wherein said pushing member, when viewed in the radial direction, has a substantially triangular shape.

24. A device as claimed in claim 16, wherein said pushing member, when viewed in the radial direction, has a substantially triangular shape.

25. A device as claimed in claim 17, wherein said pushing member, when viewed in the radial direction, has a substantially triangular shape.

26. A device as claimed in claim 18, wherein said pushing member, when viewed in the radial direction, has a substantially triangular shape.

27. A device as claimed in claim 20, wherein said pushing member, when viewed in the radial direction, has a substantially triangular shape.

28. A device as claimed in claim 14, comprising a Water Jet tool for disgregating said shoulders of said one or more tires.

29. A device as claimed in claim 28, comprising a second vertical arm having a second lower end movable in said axial direction, said Water Jet tool being fixed to said second lower end.

30. A device as claimed in claim 14, comprising means for laying one or more of said tires in said housing, substantially concentrically with said main axis.

31. A plant for disgregating tires comprising a device for destructing tires which comprise a tread and two shoulders substantially parallel to each other and substantially perpendicular to said tread, particularly for scrap tires, said device comprising:
a support for one or more of said tires, comprising a seat which is adapted to receive said one or more tires concentrically with a substantially vertical main axis,
a Water Jet system for disgregating at least one portion of said tires; and
wherein said device comprises pressing means, for pressing said shoulders of said scrap tire towards each other in said axial direction.

32. A method for disgregating the shoulders of tires which comprise a tread and two shoulders substantially parallel to each other and substantially perpendicular to said tread, particularly for scrap tires, comprising the steps of:
(a) laying one or more of said tires concentrically with a substantially vertical main axis,
(b) disgregating the tread of said one or more of said tires;
(c) moving said shoulders of said one or more tires towards each other along said main axis;
(d) disgregating said shoulders of said one or more tires.

33. A method as claimed in claim 32, wherein said step (d) is carried out by Water Jet disgregation.
